(19) United States
(12) Patent Application Publication
(10) Pub. No.: US 2018/0104662 A1
(43) Pub. Date: Apr. 19, 2018

(54) MIXER FOR FLUID PRODUCTS

(71) Applicant: ALFA S.R.L., Bologna (BO) (IT)

(72) Inventors: Edoardo ROSSETTI, Bologna (BO) (IT); Marco ROSSETTI, Bologna (BO) (IT)

(21) Appl. No.: 15/562,609

(22) PCT Filed: Apr. 18, 2016
(86) PCT No.: PCT/IB2016/052196

§ 371 Date: Sep. 28, 2017

(30) Foreign Application Priority Data
Apr. 17, 2015 (IT) BO2015A000192

(51) Int. Cl. B01F 9/00; B01F 9/10

(52) U.S. Cl. CPC B01F 9/0001; B01F 9/0016; B01F 9/10; B01F 2215/005; B01F 2009/0061; B01F 2009/0063; B01F 2009/0074

(57) ABSTRACT

A mixer for fluid products, including a base, a support structure mounted on the base and rotatable about a first axis of rotation, and a housing structure having a housing for a container of fluid products. The housing structure is mounted on the support structure at a radial distance from the first axis, and can be rotated about a second axis of rotation which is at a radial distance from the first axis. A motor is mounted on the base for transmitting a rotational movement to the support structure about the first axis a first transmission. A second transmission transmits the rotational movement to the housing structure about the second axis. The housing for a fluid product container is at a radial distance from the second axis so as to impart, during use, a combined epicyclic movement to at least one container accommodated on the housing structure.

### FIELD OF THE INVENTION

The present invention relates to a mixer for fluid products, in particular varnishes, paints, enamels, inks and the like. The invention was developed with particular regard, although not exclusively, to a mixer for fluid products contained in containers, pots, tins and the like.

### BACKGROUND OF THE INVENTION

Various mixers for fluid products of the type indicated above are known, which are designed specifically for the purpose of mixing products contained in small or medium-sized tins. These mixers are naturally placed in retail outlets for paints and the like, where the paints are often produced by means of a dispensing machine that as present dispenses colourants, in predetermined proportions, so as to produce final paints in the quantities and colours desired by users. The most widespread prior art is that of dispensing the colourants into a tin containing a white or neutral-coloured base product. After the colourants are dispensed, the paint has to be homogenised and this is done, in the simplest cases, by immersing a rotating stirrer in various shapes (scoop, blade, spiral etc.) into the fluid product. This solution is not, however, satisfactory because it is necessary to clean or replace the stirrer every time that the colour of the paint to be mixed is changed.

To resolve the disadvantages of mixers comprising rotating stirrers immersed in the fluid, many solutions have been proposed, which allow different procedures to be used for stirring the fluid contained in a tin after said tin has been sealed with its lid. U.S. Pat. No. 3,552,723 illustrates a mixer in which one or more sealed containers are made to oscillate about a horizontal axis. U.S. Pat. No. 5,066,136 relates to a vibratory mixer that allows the paint pot to be agitated, said pot remaining parallel to itself relative to a vertical plane when it moves. U.S. Pat. No. 5,507,575 relates to the principle of agitating a pot, also imparting a rotational movement about its vertical axis. U.S. Pat. No. 5,466,065 illustrates a mixer that allows the paint pot to be moved along a path that defines a cone. U.S. Pat. No. 4,281,936, U.S. Pat. No. 4,415,270, U.S. Pat. No. 5,261,744, U.S. Pat. No. 5,383,163, U.S. Pat. No. 5,788,371 and U.S. Pat. No. 5,904,421 relate to gyroscopic paint mixers, in which the pot is subjected to two superimposed rotational movements about two axes of rotation that are perpendicular to one another.

The aforementioned mixers of the prior art all achieve moderately satisfactory results when large amounts of fluid product, contained in large tins, are to be mixed, for example when used in industrial paint production plants. Their adoption for mixing small containers and small amounts of fluid products, however, often involves high costs because of the complexity of the mechanisms suited to generating the agitating or rotational movements. What is more, it has been found that with mixers of the prior art it is difficult to shorten the time needed for mixing fluid products below a certain limiting value of a few minutes, in order not to risk obtaining incomplete homogenisation of the paint.

### SUMMARY OF THE INVENTION

The object of the present invention is to produce a mixer that imparts a mixing movement to one or more fluid product containers so as to obtain optimal mixing and homogenisation of the fluid products in a short time.

Another object of the present invention is to provide a mixer for fluid products that is mechanically simple, and consequently easy and economical to manufacture, and that involves low, simple and economical maintenance.

Another object of the present invention is to provide a mixer for fluid products that is silent.

Another object of the present invention is to produce a mixer for fluid products that is maneuverable, compact and light-weight, particularly in view of its preferential intended use in retail outlets for paints, varnishes, inks and the like.

In order to achieve the above-mentioned objects, the invention relates to a fluid product mixer having the features indicated in the following claims.

According to one aspect of the invention, the fluid product mixer comprises a base on which a support structure is mounted, said structure being rotatable about a first axis of rotation. A housing structure having at least one housing for a container of fluid products to be mixed is mounted on the support structure at a radial distance from the first axis of rotation. The housing structure can be rotated about a second axis of rotation which is at a distance from the first axis of rotation. The second axis of rotation is tilted relative to the first axis of rotation. A motor is mounted on the base for transmitting a rotational movement to the support structure about the first axis of rotation by means of a first transmission. A second transmission transmits the rotational movement to the housing structure about the second axis of rotation. The at least one housing for a fluid product container is at a distance from the second axis of rotation and is preferably parallel thereto. This configuration makes it possible to produce a combined epicyclic movement of the at least one container accommodated on the housing structure. Tilting the second axis of rotation relative to the first axis of rotation produces particularly homogeneous mixing.

Advantageously, the first axis of rotation is vertical and a counterweight is positioned radially opposite the support structure so as to balance the centrifugal force thereof during the rotational movement about the first axis of rotation.

Advantageously, the second axis of rotation is tilted by approximately 30° relative to the vertical. This tilting favours homogeneous mixing inside the container, which is also tilted relative to the vertical. At the same time, the need to provide a system for holding the container is avoided, since said container remains stable in its housing during the mixing movement without having to be locked from above as is sometimes the case in mixers of the prior art.

According to a particular aspect, the housing structure of the mixer comprises three housings for three respective containers of fluid products to be mixed. These three housings are arranged symmetrically about the second axis of rotation so as to be balanced during the rotational movement about said axis. The three-housing arrangement obviously allows for the productivity of the mixer to be three times that of systems of the prior art, which mix just one fluid product container at a time.

According to another particular aspect, the one or more housings for fluid product containers are mounted on the housing structure at a radial distance from the second axis of rotation. Each housing can also be rotated about a third axis of rotation which is substantially parallel to the second axis of rotation. This third axis of rotation substantially coincides with an axis of symmetry of the housing, and therefore of the container of fluid product to be mixed. In substance, with this configuration, all fluid product containers are subject to a movement that is the combination of three rotations: a rotation about their own axis of symmetry, a revolution about the second axis of rotation, preferably, but not restrictively, tilted by approximately 30° relative to the vertical, and a further rotation about the first axis of rotation which is preferably, but not restrictively, vertical. The mixing of the fluid products that can thereby be achieved inside the container is very homogeneous and takes place fairly quickly.

According to another particular aspect, the mixer of the present invention comprises a motor mounted on the base and coupled to a transmission shaft that can be rotated about the first axis of rotation. One end of this transmission shaft is fixed to the support structure which comprises a plate having a flat central portion and two side wings tilted by approximately 30° relative to a horizontal plane. The housing structure is mounted on one of the side wings, while a counterweight is mounted on the opposite side wing. This configuration is simple to produce, particularly sturdy and economical to manufacture.

According to another particular aspect, the mixer comprises a fixed pulley which is coaxial with the first axis of rotation and a moveable pulley which is coaxial with the second axis of rotation. The fixed pulley and the moveable pulley are coupled by means of a transmission belt that is guided at an angle by two idler rollers. The movement is transmitted simply and automatically with no need to provide a second motor. Furthermore, the arrangement of the idler rollers makes it possible to keep the transmission belt centred in a simple manner despite the tilting of the axes of the two pulleys relative to one another.

According to another advantageous aspect, the mixer comprises a toothed wheel which is mounted so as to be fixed on the support structure and is coaxial with the second transmission axis. The housings for the fluid product containers are each mounted on a respective rotatable spindle, on which, in turn, a toothed wheel which meshes with the toothed wheel mounted so as to be fixed, fits perfectly. The transmission system is simple and reliable and makes it possible for the fluid product containers to rotate about their own axes without having to provide additional motors.

According to another particular aspect, each housing for the fluid product containers is substantially truncated-cone-shaped. In this way, it is possible to accommodate and hold the containers with slight interference.

According to another particular aspect, the base of the mixer comprises a platform on which a support base is mounted with interposed resilient anti-vibration means. A bearing plate is raised above the support base, under which bearing plate the motor is mounted. The motor controls a vertical transmission shaft that passes through the bearing plate and to the upper end of which the support structure is fixed. This configuration proves robust, simple and economical, and permits good isolation of the vibrations induced by mixing the fluid product containers.

### BRIEF DESCRIPTION OF THE FIGURES

Further features and advantages will become apparent from the following detailed description of some preferred embodiments, with reference to the attached drawings, given purely by way of non-restrictive example, in which:

FIG. 1 is a perspective view of a mixer of the present invention shown without an outer protective casing for better understanding;

FIG. 2 is a plan view of the mixer in FIG. 1;

FIG. 3 is a section along the line A-A in FIG. 2;

FIG. 4 is a section along the line B-B in FIG. 2; and

FIG. 5 is a cross-section through a variant of the portion of the unit supporting the fluid product containers.

### DETAILED DESCRIPTION OF PREFERRED EMBODIMENTS

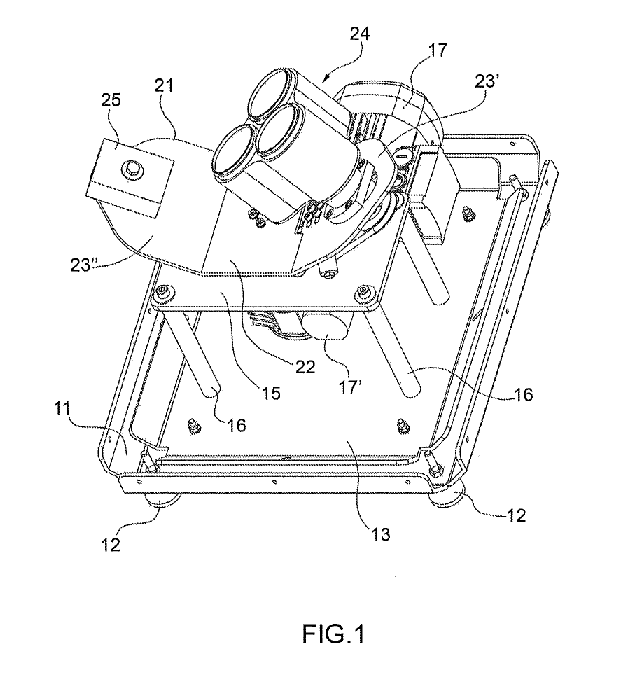

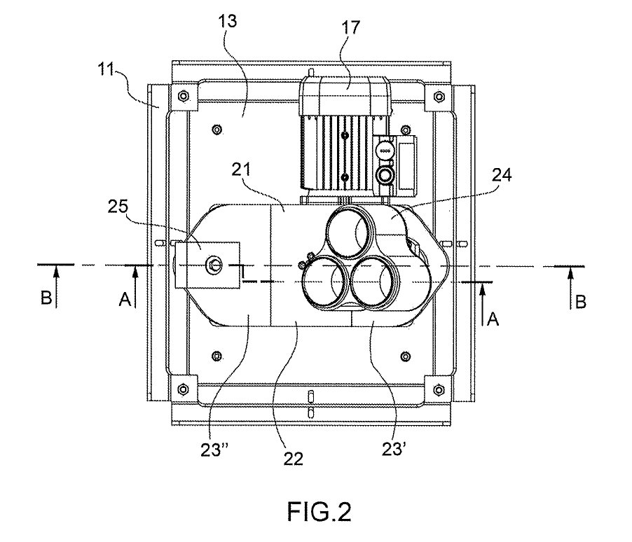

With reference now to FIGS. 1 to 4, a mixer for fluid products, in particular varnishes, paints, enamels, inks and the like is indicated in general by the reference numeral 10. The mixer 10 comprises a platform 11 mounted on feet 12 which are preferably independently height-adjustable. A protective casing is fixed to the platform 11, said casing being omitted from the drawings for illustrative clarity. The protective casing is provided with a hatch for access inside the mixer. The mixer can also be produced without a casing when it is positioned inside a more complex machine, for example an automatic paint-dispensing machine.

A support base 13 is mounted on the platform 11 with interposed resilient anti-vibration blocks 14 (see FIG. 4), which dampen the vibrations transmitted from the mixer during operation thereof. A bearing plate 15 is raised above the support base 13 and is supported by four columns 16 fixed to the support base 13. A motor 17 is mounted under the bearing plate 15 and controls a transmission shaft 18 positioned vertically, optionally with a reduction unit 17′ interposed, preferably a bevel gear unit. The transmission shaft 18 passes through the bearing plate 15 and has at its upper end a flange 20, by means of which it is fixed to a rotary plate 21.

The rotary plate 21 has a horizontal central zone 22 from which two opposite wings 23′, 23″ extend at an angle to a horizontal plane. Preferably, although non-restrictively, the wings 23′, 23″ are angled by approximately 30° relative to a horizontal plane. A rotary support unit 24 is mounted on one of the two wings 23′, while a counterweight 25 is mounted on the opposite wing 23″.

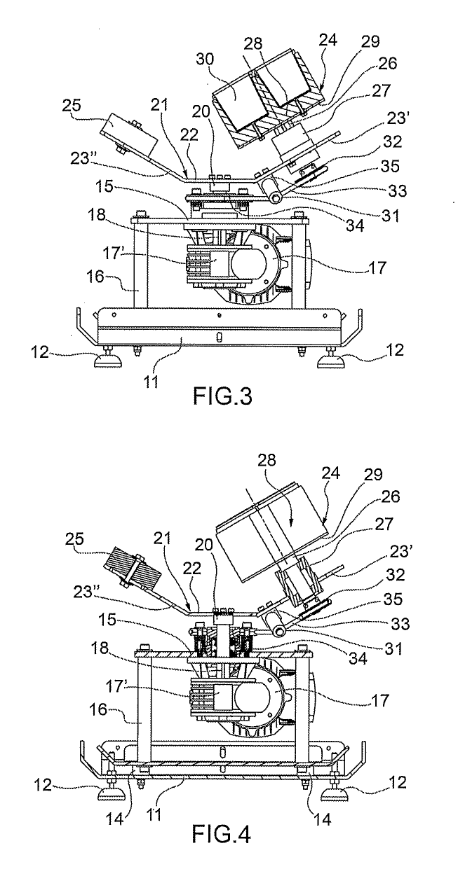

The support unit 24 is mounted on an idler shaft 26, which can rotate when idling about an axis that is perpendicular to the plane of the wing 23′ on which the support unit 24 is mounted. Preferably, therefore, the idler shaft 26 is tilted by approximately 30° relative to the vertical. The idler shaft 26 is mounted, preferably with interposed ball bearings, on a bushing 27 which is fixed to the wing 23′, and supports a housing unit 28 for the containers of fluid product to be mixed. In particular, in the example in the figures, the housing unit 28 comprises three housings arranged symmetrically about the axis of the idler shaft 26. The configuration in the example is that which has demonstrated the best performance in terms of mixing fluid products, with specific reference being made to small containers, for example between 50 and 200 mL, and preferably 100 mL. It is, however, possible to vary both the number and arrangement of the housings for containers. For example, a single housing could be provided for a larger container, for instance half a litre or more, which is positioned so as to have its axis in line with the axis of the idler shaft 26, or offset therefrom. As can be seen in FIG. 3, the housing unit 28 is mounted on a plate 29 by means of screws or similar, for easier replacement with an identical or different housing unit. The housing unit 28 comprises three cavities 30 which are substantially truncated-cone-shaped for accommodating the same number of containers of fluid product to be mixed having the same shape. The size of the cavities 30 is such as to be able to accommodate the containers and hold them by means of slight interference owing to their truncated-cone shape. The housing unit 28 is, however, tilted such that no centrifugal forces are generated during use that might push the containers out of the corresponding cavities 30. In other words, unlike many mixers of the prior art, for example vibrational or gyroscopic mixers, it is not necessary in the mixer of the present invention to provide a stop or a cover to hold the fluid product containers from above. Actually, the force of gravity, and if appropriate the slight interference in the cavity 30, is sufficient to hold the containers in position. This is an advantage because it simplifies the mixing operations, reduces the risks of incorrect positioning of the containers, and reduces the need to provide alarms or complicated clamping systems.

The housing unit 28 is preferably configured so that none of the cavities 30 extend beyond the vertical axis of rotation of the transmission shaft 18. A moveable pulley 32 is fixed to the lower end of the idler shaft 26, said pulley being connected by a transmission belt 33 to a fixed pulley 34 which is mounted on the bearing plate 15 and is coaxial with the transmission shaft 18. The belt 33 is guided at an angle from one pulley to the other by means of two idler rollers 31 which can be rotated when idling so as to have substantially horizontal axes. The idler rollers 31 are mounted on supports 35 fixed to the rotary plate 21, substantially at the bend between the central horizontal zone 22 and the angled wing 23′ that supports the housing unit 28. The adoption of the idler rollers 31 instead of idling guide pulleys allows for the transmission belt 33 to be kept constantly aligned between the moveable pulley 32 and the fixed pulley 34.

When the mixer in the example in FIGS. 1 to 4 is operating, three containers of fluid product to be mixed are placed in the cavities 30 in the housing unit 28. It is of course possible to also operate the mixer with two or just one fluid product container inserted into the cavities 30 in the housing unit 28, or even with four or more containers. The imbalance that is generated in this way through the asymmetry of loading can be anticipated during the design phase and taken into consideration when determining the sizes of the mixer components.

The motor 17 is activated so as to put into rotation, in a predetermined direction and at a predetermined speed, the transmission shaft 18 and therewith the rotary plate 21, which in turn drives the housing unit 28 in rotation about its vertical axis, the weight of said housing unit being counterbalanced by the counterweight 25. The rotation of the housing unit 28 about the axis of the transmission shaft 18 causes the moveable pulley 32 mounted on the lower end of the idler shaft 26 to rotate in a manner controlled via the belt 33 by the fixed pulley 34 which is coaxial with the transmission shaft 18. The rotational movement about the axis of the idler shaft 28 is therefore superimposed on the rotational movement about the vertical axis of the transmission shaft 18, combining as an epicyclic movement. The tilting of each container relative to the vertical adds a vertical component to the movement of each particle of fluid contained inside each fluid product container accommodated in the cavities 30. The result is uniform mixing, in a short period, of the fluid product contained in the containers accommodated in the cavities 30 of the housing unit 28.

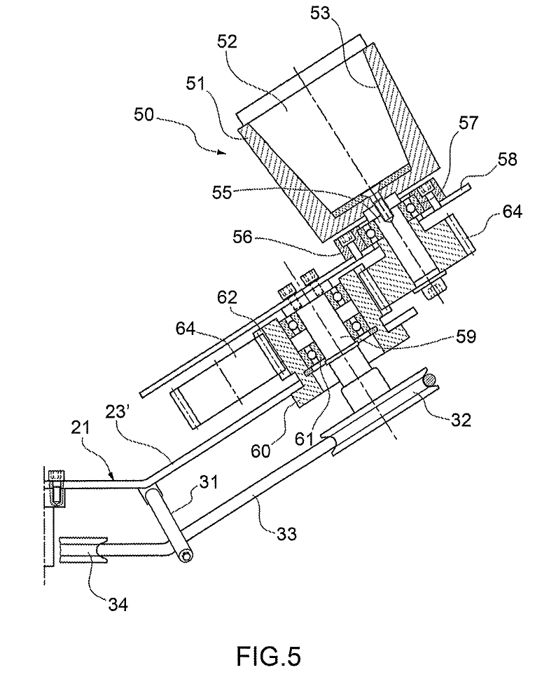

FIG. 5 illustrates a variant of the mixer of the present invention, in which a housing unit 50 comprises one or more cups 51 for accommodating fluid product containers 52 that can subsequently rotate about their own axis. Each cup 51 (of which only one is depicted in FIG. 5, for illustrative simplicity) comprises a cavity 53 for accommodating a container 52 of fluid products to be mixed. The cavity 53 is preferably truncated-cone-shaped in order to hold the container 52 with slight interference. The tilting of each cup 51, the axis of which is preferably at approximately 30° relative to the vertical, is such that, as in the example previously described, it is not necessary to provide a system for holding the containers 52 from above.

Each cup 51 is supported in rotation by a spindle 55 supported by a hub 56, preferably with interposed ball bearings 57. The hub 56 is fixed to a support plate 58. An idler shaft 59 is fixed to the centre of the support plate 58, which idler shaft, like the idler shaft 28 of the previous example shown in FIGS. 1 to 4, is mounted on one wing 23′ of the rotary plate 21 by means of a bushing 60, preferably with interposed ball bearings 61. The moveable pulley 32 is mounted at the lower end of the idler shaft 59, said pulley being connected, as stated above, to the fixed pulley 34 which is coaxial with the transmission shaft 18 by means of the transmission belt 33 guided by the idler rollers 31.

A central toothed wheel 62 is mounted so as to be fixed and coaxial with the bushing 60 that supports the idler shaft 59. Alternatively, the central toothed wheel 62 can be produced in one piece on the outer surface of the said bushing 60. Three toothed wheels 64, each fixed to the lower end of the particular support spindle 55 of one of the cups 51, mesh with one another on the central toothed wheel 62.

According to an alternative embodiment, instead of toothed wheels meshing with one another, friction wheels or pulleys connected to one another by a transmission belt can be provided.

During the operation of the fluid product mixer according to the variant in FIG. 5, the motor 17 is excited so as to put into rotation in a predetermined direction and at a predetermined speed the transmission shaft 18 and therewith the rotary plate 21, which in turn drives the housing unit 50 in rotation about its vertical axis, the weight of said housing unit being counterbalanced by the counterweight 25. The rotation of the housing unit 50 about the axis of the transmission shaft 18 causes the moveable pulley 32 mounted at the lower end of the idler shaft 59 to rotate in a manner controlled via the transmission belt 33 by the fixed pulley 34 which is coaxial with the transmission shaft 18. As in the preceding example, the rotational movement about the axis of the idler shaft 59 is therefore superimposed on the rotational movement about the vertical axis of the transmission shaft 18, and this causes the support plate 59 to rotate about the axis of the idler shaft 59. The rotation of the support plate 59 then causes the toothed wheels 64 to rotate on the central toothed wheel 62, consequently rotating each cup 51, and therefore each container 54 of fluid products, about its own axis, such that it is tilted relative to the horizontal. In substance, the movement of each particle of fluid product inside each container 54 is subject to (a) a rotational movement about the axis of the container 54 as a result of the rotation of the cup 51 about the axis of the spindle 55, (b) a movement of revolution about the axis of the idler shaft 59 as a result of the rotation imparted to the moveable pulley 32 by the fixed pulley 34 via the transmission belt 33, and (c) a movement of translation about the vertical axis of the transmission shaft 18 as a result of the rotation imparted by said transmission shaft to the rotary plate 21 that supports the housing unit 50. Furthermore, the tilting of each container 54 relative to the horizontal plane causes the particles of fluid product inside each container 54 to be remixed in the vertical direction so as to obtain homogenous mixing in a short period.

Of course, without prejudice to the principle of the invention, the embodiments and the implementation details can vary greatly from what is described and illustrated while remaining within the scope of the present invention.

1. Mixer for fluid products, comprising a base, a support structure mounted on the base and rotatable about a first axis of rotation, and a housing structure having at least one housing for a container of fluid products to be mixed, which housing structure is mounted on the support structure at a radial distance from the first axis of rotation, the housing structure being rotatable about a second axis of rotation relative to the first axis of rotation, a motor being mounted on the base for transmitting a rotational movement to the support structure about the first axis of rotation by means of a first transmission, a second transmission transmitting the rotational movement to the housing structure about the second axis of rotation, the at least one housing for a fluid product container being at a radial distance from the second axis of rotation so as to impart, during use, a combined epicyclic movement to at least one container accommodated on the housing structure.

2. Mixer for fluid products according to claim 1, wherein the first axis of rotation is vertical, a counterweight being positioned radially opposite the support structure so as to balance the centrifugal force thereof during the rotational movement about the first axis of rotation.

3. Mixer for fluid products according to claim 1, wherein the second axis of rotation is tilted, preferably by about 30°, relative to the vertical.

4. Mixer for fluid products according to claim 1, wherein the housing structure comprises three housings for three respective containers of fluid products to be mixed, the housings being arranged symmetrically about the second axis of rotation.

5. Mixer for fluid products according to claim 1, wherein each of said at least one housing is mounted on the housing structure at a radial distance from the second axis of rotation, and is rotatable about a third axis of rotation which is substantially parallel to the second axis of rotation, the third axis of rotation substantially coinciding with an axis of symmetry of the housing for the container of fluid product to be mixed.

6. Mixer for fluid products according to claim 1, comprising a motor mounted on the base and coupled to a transmission shaft that can be rotated about the first axis of rotation, one end of the transmission shaft being fixed to the support structure which comprises a plate having a flat central portion and two side wings tilted by approximately 30° relative to a horizontal plane, the housing structure being mounted on one side wing and a counterweight being mounted on the opposite side wing.

7. Mixer for fluid products according to claim 1, comprising a fixed pulley which is coaxial with the first axis of rotation and a moveable pulley which is coaxial with the second axis of rotation, the fixed pulley and the moveable pulley being coupled by means of a transmission belt that is guided at an angle by two idler rollers.

8. Mixer for fluid products according to claim 5, comprising a toothed wheel which is mounted so as to be fixed on the support structure and is coaxial with the second transmission axis, each of said at least one housing being mounted on a respective rotatable spindle, on which a toothed wheel, which meshes with the toothed wheel mounted so as to be fixed, fits perfectly.

9. Mixer for fluid products according to claim 1, wherein each housing is substantially truncated-cone-shaped in order to accommodate a corresponding fluid product container with slight interference.

10. Mixer for fluid products according to claim 1, wherein the base comprises a platform on which a support base is mounted, with interposed resilient anti-vibration means, a bearing plate raised above the support base, under which support plate the motor is mounted, which motor controls a vertical transmission shaft that passes through the bearing plate and to the upper end of which the support structure is fixed.
